(19) United States
(12) Patent Application Publication
(10) Pub. No.: US 2024/0206472 A1
(43) Pub. Date: Jun. 27, 2024

(54) BIOCIDAL COMPOSITION AND METHOD FOR ELIMINATION OF INVASIVE CORALS IN UNDERWATER CONDITIONS

(71) Applicants: PETRÓLEO BRASILEIRO S.A. - PETROBRAS, Rio de Janeiro (BR); UNIVERSIDADE ESTADUAL DE CAMPINAS, Campinas (BR)

(72) Inventors: Edvaldo SABADINI, Campinas (BR); Suelen Gauna TRINDADE, Campinas (BR); Matheus Da Silva BARBOSA, Campinas (BR); Fernando Bonin OKASAKI, São Paulo (BR); Victor Augusto Licio Garcia VILELA, Campinas (BR); Renato Nunes DE SOUZA, Campinas (BR); Carlos SPEGLICH, Jundiai (BR)

(21) Appl. No.: 18/545,861

(22) Filed: Dec. 19, 2023

(30) Foreign Application Priority Data
Dec. 21, 2022 (BR) BR 1020220262004

(51) Int. Cl. A01N 59/00; A01N 25/04; A01P 15/00

(52) U.S. Cl. CPC A01N 59/00; A01N 25/04; A01P 15/00

(57) ABSTRACT

The present invention relates to a biocidal composition and a method for eliminating invasive corals of the genus Tubastraea (sun coral) in a marine environment, using polymeric gels for in situ application to cover the surface of bioscaling, which act through a suffocation mechanism and/or poisoning through the administration of chemical biocides, with maximum lethality after 72 hours of up to 94%, for a single application.

### FIELD OF THE INVENTION

The present invention refers to a biocidal composition and a method for eliminating invasive corals of the genus Tubastraea (sun coral) in a marine environment, using polymeric gels for in situ application to cover the surface of bioscaling, which act by suffocation mechanism and/or poisoning through the administration of chemical biocides.

The present invention has application in the control of marine bioscaling, mainly sun coral, through the administration of biocidal agents in a localized and concentrated manner.

### BACKGROUND OF THE INVENTION

The coral species Tubastraea tagusensis and Tubastraea coccinea, popularly known as sun coral, are invasive exotic species with increasing dissemination on the Brazilian coast. These species have a high potential for invasion, with rapid and increasing proliferation in natural and artificial substrates, which threaten native biodiversity and have been causing serious ecological and socioeconomic impacts in the regions where they settle.

In view of the potential threat that sun coral represents, there is an urgent need to develop strategies that are efficient both in preventing new introductions and in controlling the proliferation of sun coral in affected regions. However, the development of technologies for this purpose presents many challenges, since the proposed solution must be biologically and ecologically compatible with management in a marine environment without representing a greater risk than the sun coral itself for the native species that cohabit the treated areas. Furthermore, the technology must be scalable to a magnitude that allows its application across the entire Brazilian coast.

Currently, the main control strategy that has been adopted by the National Plan for Preventing, Controlling and Monitoring sun coral (Tubastraea spp.) in Brazil is based on management through manual scraping by divers. This strategy, in addition to being a high-risk and high-cost activity, has limited efficiency and is not applicable in difficult-to-access locations. Furthermore, the mechanical aggression applied during the operation can cause the release of larvae and residues that can disperse and form new infestation points.

Due to the increasing dispersion of sun coral on the coast of Brazil, the impacts associated with the invasion and the high human and financial cost linked to the manual scraping method, the Brazilian State, together with various economic sectors, considers research and development to be a priority of new technologies to mitigate such impacts through the prevention, control and monitoring of sun coral.

Recently, there has been an increase in the number of publications presenting new methods for managing bioscaling, among which the following stand out: direct administration of chemical biocides, wrapping with biocide administration, anti-scaling paints and operating remote control vehicles (ROVs) for scraping and removing bioscaling.

Experimental studies in the literature have already explored the strategy of direct administration of chemical biocides such as acetic acid and sodium hypochlorite to combat sun coral bioscaling. Some of these studies have demonstrated the effectiveness of directly applying different concentrations of acetic acid for controlling sun coral bioscaling. However, the direct administration of biocides in solution presents several limitations for application in the marine environment. In addition to the rapid dilution of the biocidal agent, which can reduce its effectiveness in combating the target organism, this strategy can pose risks to neighboring native organisms that are also sensitive to the biocide, causing undesirable damage to the ecosystem. Therefore, the application of this methodology is limited by the concentration and toxicity of the biocide used.

In the wrapping strategy, bioscaling control occurs through the chemical action of the biocide and the limitation of food and oxygen. In this strategy, the hull of small vessels is isolated with plastic films or even floating docks, enabling the addition of biocides and preventing the occurrence of leaks and the escape of bioscaling material into the sea. Among the biocides used for this purpose and which have already been reported in the literature to combat sun coral are acetic acid, sodium hypochlorite and fresh water. However, the feasibility of applying this strategy is restricted to small vessels and is not applicable to platforms and natural environments such as rocky shores and reefs.

The Patent EP 2925820 (B1) relates to an anti-corrosive and anti-bioscaling coating, which is a sol-gel, and to a method of preparing this coating. The main purpose of the document is to inhibit the corrosion of metallic substrates by controlling the microorganisms responsible for causing this process (Microorganism Induces Corrosion, MICs), and only touches on the topic of bioscaling by placing bioscaling environments as conducive to the proliferation of microorganisms that cause corrosion. The polymeric matrix used in the European patent comes from silicone polymers, incorporates microorganisms to combat MICs and contains organic or inorganic additives for anti-corrosion purposes. Therefore, it has ecological incompatibilities with application in a large-scale marine environment. The biocidal and anticorrosive strategies used also have metallic components that are incompatible with large-scale application in the marine environment. The use of microorganisms to combat MICs could also generate biological and ecological problems, in addition to the fact that several physical and chemical variables must be controlled to guarantee the survival and effectiveness of these microorganisms, which is difficult to carry out in a marine environment. The methodology described is carried out in a non-submerged environment and requires manipulation of the local temperature to cure its gels, which makes its offshore administration unfeasible. Due to the divergent purposes, the material and methodology shown in the document would not be as efficient in combating sun coral since the main purpose of the biocidal components is to attack microorganisms, and not directly directed at a cnidarian, as in the present invention. The polymeric matrix of the present invention has greater ecological compatibility with the application environment than the polymeric matrix of the invention of the document. The European patent application methodology is not carried out submerged even though, after its application, the substrates are introduced into the marine environment, in addition, the curing stage of the invention material depends on controlled temperature variation, which is not feasible in an open marine environment and also requires coordinate control for the effectiveness of microorganisms. The method of the present invention was developed for application in a marine environment and submerged without the need to manipulate variables regarding the environment in which it is applied, which makes its application even in offshore situations viable.

The patent application BR 102020021103 relates to a mechanical system for removing scale, especially sun coral, from large marine units. The system controls bioscaling, including sun coral, through a mechanical suction and crushing methodology using a mechanical device, but still dependent on the assistance of divers, which makes offshore operations unfeasible. The system uses filters as a solution for the release of larvae, a problem commonly mentioned when addressing bioscaling control from mechanical aggression. The suction and crushing system still generate a large amount of waste with biological contaminants, the disposal of which would be challenging in a hypothetical offshore operation. Differently, the present invention controls the emission of larvae during the attack on sun coral without generating a large amount of waste with contaminating biological material and without the need to use filters that must be continually changed to ensure good efficiency. Furthermore, the present invention, as it is capable of being executed with remotely operated drones, makes its application in an offshore environment viable.

The review article by Altvater et al (2016) entitled “Use of sodium hypochlorite as a control method for the non-indigenous coral species Tubastraea coccinea Lesson, 1829” describes a study that evaluated the effects of sodium hypochlorite on colonies of Tubastraea coccinea, concluding that this component can be applied to control invasive coral, both in artificial and natural substrates. Exposure to sodium hypochlorite was conducted in the laboratory under controlled conditions in aquariums filled with seawater. Despite the high biocidal capacity of sodium hypochlorite in combating Tubastraea coccinea corals reported in the related document, the authors do not provide any discussion on how the administration of this biocide should be carried out in the marine environment. On the other hand, in the present patent application, sodium hypochlorite is used as a biocidal agent, but incorporated into a sodium alginate polymeric matrix, which after application and cross-linking in situ in a marine environment, is capable of controlling the release of biocide from specific and localized form on the surface of bioscaling in a real marine environment.

The scientific article by Creed et al (2021) entitled “Multi-site experiments demonstrate that control of invasive corals (Tubastraea spp.) by manual removal is effective” describes a study that tests the efficiency of manually removing corals (physics), indicating some positive results, but concluding that it should be a complementary method. The document relates to a systematic study on the efficiency of various mechanical removal methodologies for sun coral, whose problems are the release of larvae during mechanical removal, which ends up continuing the infestation, and the dependence on direct human action in its implementation, normally by divers, which makes the process more expensive and dangerous, in addition to making it unfeasible to carry out in an offshore environment. Otherwise, the present invention, as it is based on coating with gel loaded with biocidal substances, does not allow the release of larvae during the attack on sun coral colonies and can be entirely carried out via remotely operated drones, thus, it does not require assistance from divers and enables its implementation in an offshore environment.

The scientific article by Turbiani & Kieckbusch (2011) entitled “Release of calcium benzoate from sodium alginate films cross-linked with calcium ions” describes a study on the release of calcium benzoate and which uses calcium chloride as a cross-linker together with sodium alginate. In the document, the entire study revolves around the formation of films with controlled dimensions, therefore, its conclusions cannot be extended to depositions of material that do not form films. Thus, the formation of films requires very controlled experimental conditions so that the deposited material actually forms a film. Under the application conditions posed by the present invention, it will be impossible to exercise almost any control over the external conditions of material deposition. The release of calcium benzoate alters the rheological properties of the materials studied, since the calcium ion is responsible for cross-linking the alginate polymeric network. Therefore, the mechanical and release properties of the material studied vary considerably over time. Furthermore, there is no mention of the effect of external coordinates, such as ionic strength, pH, among others, on the release of the substance of interest. Therefore, every study is based on the formation of films in controlled and non-submerged conditions, something that is not achievable in an application in a marine environment, even more in an offshore situation. Differently, in the present invention, the substances released by the polymeric matrix are not responsible for considerable rheological modifications of the gel and are released from the polymeric matrix when applied in a marine environment, without having a significant radial reach due to the fact that they are very reactive components, which makes the present invention ecologically viable when applied in situ in a marine environment.

Thus, the documents from the state of the art that describe the fight against sun coral using chemical agents such as biocides are works conducted in a controlled situation with high dependence on control parameters, thus distancing themselves from a methodology that could be applied in real situations and environments. The documents that describe the fight against sun coral using mechanical removal are deficient regarding the release of larvae during its implementation and the dependence on the assistance of divers. The documents that describe the properties of sodium alginate distance themselves from the present invention because they do not consider central properties of the invention, such as the ability to adhesion in submerged conditions and promote in situ cross-linking in a marine environment, and do not demonstrate compatibility with sodium hypochlorite, its ability to cross-link in the presence of calcium ions and its ability to release chemicals when in film form.

In view of the above, it would be useful if the technique had a method capable of solving the bioinvasion of exotic corals Tubastraea tagusensis and Tubastraea coccinea, popularly known as sun coral, on the Brazilian coast.

### BRIEF DESCRIPTION OF THE INVENTION

The present invention relates to a biocidal composition and a method for eliminating invasive corals of the genus Tubastraea (sun coral) in a marine environment, using polymeric gels for in situ application to cover the surface of bioscaling, which act by mechanism of suffocation and/or poisoning through the administration of chemical biocides.

The biocidal composition is for eliminating invasive corals of the genus Tubastraea (sun coral) in the marine environment and comprises:
1) Biocidal gel:
   1 to 10% w/w sodium alginate;
   0.25 to 10% w/v sodium chloride;
   0.05 to 5% w/w sodium hypochlorite; and
2) Cross-linking agent:
   0.2 to 0.8 g/mL of calcium chloride (CaCl₂)).
Given that:
   Sodium alginate can be replaced by water-soluble biopolymers selected from the group of chitosan, pectin, guar gum or cellulose;
   Sodium chloride can be replaced by density controlling additives selected from the group of hydroxide and/or metal oxides of families 1A and 2A, calcite, hematite, sand, silt or fine limestone, preferably 0.4 to 4% w/w sodium, magnesium, potassium and/or calcium chlorides and hydroxides;
   Sodium hypochlorite can be replaced by chemical biocides selected from the group of acetic acid and ammonium persulfate;
   Calcium chloride (CaCl₂)) can be replaced by cross-linking agents selected from the group of ammonium persulfate and inorganic minerals that make up Portland cement.

The method for eliminating invasive corals comprises the steps:
a) Preparation of the biocidal composition described above;
b) Application of the biocidal gel within 6 hours after preparation (step a) by pumping until the bioscaling is completely covered by the biocidal gel;
c) Application of the cross-linking solution by pumping the region covered by the biocidal gel (step b) until the biocidal gel is completely covered; and
d) Keep the biocidal composition covering the coral colonies for at least 48 hours.

### BRIEF DESCRIPTION OF THE FIGURES

FIG. 1 shows the distribution of groups and subgroups of sun coral colonies in the experimental tank. The exposure time intervals to the gel formulations are indicated by the arrows.

FIG. 2 shows the distribution of groups of sun coral colonies in the aquarium. The exposure time intervals to the formulation are indicated by the arrows.

FIG. 3 shows, from left to right, the records: front, back and top of the sun coral colonies.

FIG. 4 shows the mechanical removal of the biocidal composition from a sun coral colony.

FIG. 5 shows the schematic representation of the polyp count in a sun coral colony. The regions demarcated by dotted circles correspond to coral polyps.

FIG. 6 shows images of the control (left) and experimental (right) tanks before the start of the experiments.

FIG. 7 shows images of the control (left) and experimental (right) tanks after 48 hours of applying the gels.

FIG. 8 shows the graph correlating the gel exposure time with the average lethality of each group of colonies.

FIG. 9 shows images of a colony coated with the biocidal composition after its removal from the experimental tank, moments before removing the formulation. The image indicates that both administering stages of the composition were satisfactory because the application of the gel under the colony completely covered the polyps and the cross-linker provided high final rigidity to the biocidal composition.

FIG. 10 represents the mechanical removal of gel from reapplication.

FIG. 11 shows the graph correlating gel exposure time and average lethality for each group, comparing the subgroups where there was reapplication (red) or single application (black).

FIG. 12 shows the image of the test aquarium of formulation 3 after applying the gel.

FIG. 13 shows comparative images of the control colonies in the aquarium of formulation 3 (above) at the beginning and at the end of the experiment. Images of colonies that received formulation 3 at different periods (below) and after the end of the experiment.

FIG. 14 shows the image of the mechanical removal of gel from formulation 5 from a sun coral colony.

### DETAILED DESCRIPTION OF THE INVENTION

The present invention relates to a biocidal composition and a method for eliminating invasive corals of the genus Tubastraea (sun coral) in a marine environment, using polymeric gels for in situ application to cover the surface of bioscaling, which act by suffocation mechanism and/or poisoning through the administration of chemical biocides.

The biocidal composition comprises:
1) biocidal gel:
   1 to 10% w/w water-soluble biopolymers selected from the group of sodium alginate, chitosan, pectin, guar gum or cellulose;
   0.25 to 10% w/v density control additives selected from the group of salts, hydroxides and/or metal oxides from families 1A and 2A, calcite, hematite, sand, silt or fine limestone, preferably 0.4 to 4% w/w sodium, magnesium, potassium and/or calcium chlorides and hydroxides; and
   0.05 to 5% w/w chemical biocides selected from the group of sodium hypochlorite, acetic acid or ammonium persulfate;
2) Cross-linking agents with a concentration of 0.2 to 0.8 g/mL selected from the group of calcium chloride (CaCl₂)), ammonium persulfate and inorganic minerals that make up Portland cement.

The biocidal composition was obtained as follows:
A. Preparation of biocidal gel with final viscosity varying between 1,000 and 100,000 cP from the addition of the following components to water, under mechanical stirring at 600 rpm using a low shear rotor, in sequence:
   1 to 10% w/w water-soluble biopolymers that form the polymeric matrix;
   0.25 to 10% w/v additives for density control;
   0.05 to 5% w/w chemical biocides; and
B. Preparation of the cross-linking solution by adding 0.2 to 0.8 g/mL of cross-linking agent to distilled water under mechanical stirring at 800 rpm.

The method for eliminating invasive corals using the biocidal composition comprises the following steps:
a) Preparation of the biocidal composition: the biocidal gel and the cross-linking solution must be prepared shortly before application, up to a maximum of 6 hours after preparation. Both the composition of the biocidal gel and the cross-linking solution require adjustments to optimize their properties (in particular rheology, density and stability) according to the characteristics of the treated substrate and operating conditions;
b) Application of the biocidal gel within a maximum of 6 hours after preparation: from the reservoir, the gel must be pumped through a duct to the region to be treated. The pumping conditions during application (especially flow and pressure) must vary according to the characteristics of the operation, and the system must be adapted to ensure complete coverage of the bioscaling by the biocidal gel, forming a covering over the colonies in such a way to isolate them from the environment; and
c) Application of the cross-linking solution: from the reservoir, the solution must be pumped through a duct to the region covered by the biocidal gel. The cross-linker pumping conditions (especially flow and pressure) are also dependent on the operation and must be adjusted to ensure application of the cross-linker solution onto the biocidal gel and contact for sufficient time to provide rigidity to the system; and
d) Maintain the biocidal composition covering the coral colonies for a period of 48 to 72 hours to achieve lethality close to 100%.

The technology was developed to be compatible with the pumping system of its components and for application in underwater conditions. In this way, the method allows the application of the biocidal composition manually, by divers, or remotely (diverless) using underwater remotely operated vehicles (ROV).

### EXAMPLES OF IMPLEMENTATION

The embodiment examples correspond to effectiveness tests of the method using different biocidal gel formulations in laboratory experiments with sun coral colonies of the species Tubastraea tagusensis.

The method was tested using the following formulations:
(1) Polymeric matrix of sodium alginate solubilized in deionized water with a mass percentage varying within the range of 1.0 to 5.0% (w/w) and thickened with sodium chloride (NaCl—40 g/L), containing sodium hypochlorite (content: 0.05 to 1.0%) (w/w) as chemical biocide and cross-linked in situ, during application to the substrate, with calcium chloride solution (CaCl₂));
(2) Polymeric matrix of sodium alginate solubilized in deionized water with a mass percentage varying within the range of 1.0 to 5.0% (w/w) and thickened with sodium chloride (NaCl—40 g/L), with addition of inorganic minerals that make up Portland cement (1.0 to 6.0% (w/w)) immediately before application to the substrate.

The method was developed to be compatible with the pumping system and for application in underwater conditions. The polymeric matrix is pumped and applied in non-cross-linked form, to ensure efficient adhesion and coverage of the substrate surface. Subsequently, the in situ cross-linking of the polymeric matrix by the addition of the cross-linking agent guarantees a gain in rigidity of the material, increasing its mechanical resistance under tidal conditions and reducing the diffusion rate of the biocidal agent to the external environment.

In this way, the release of the chemical biocide occurs locally and concentrated on the surface of the substrate, ensuring faster and more effective action and reducing the impact on neighboring native organisms. In addition to the action of the chemical biocide, the cross-linked gel also acts through a suffocation mechanism. The physical barrier of the cross-linked gel on the surface of the colonies makes gas exchange and feeding processes difficult, leading to the death of organisms through suffocation and starvation, which can contribute to greater effectiveness of treatment against these organisms and even expand the range of organisms that can be eradicated by the method of the present invention.

Tests on colonies of Tubastraea tagusensis have already demonstrated the success of the method using a composition containing a load of the biocide sodium hypochlorite of 0.17% (w/w). A lethality rate of 90% was achieved when colonies were exposed to a single application for 48 hours, reaching 100% after 72 hours of contact. When colonies were exposed to two sequential applications, 98% lethality was achieved with just 6 hours of exposure, reaching 100% after 24 hours of exposure.

To control bioinvasion, laboratory tests with the method of the present invention were conducted with sun coral colonies (Tubastraea tagusensis and Tubastraea coccinea species). However, the method can be applied to other types of bioscaling organisms that are susceptible to the presence of sodium hypochlorite, the biocide used in the present invention, as the dosage can be controlled in order to overcome the tolerance levels of those more resistant organisms. As an example of bioscaling agents that can be included in tests to adapt the method of the present invention, those that have high susceptibility to active chlorine can be mentioned. These include: the marine worm Sabella spallanzanii, several species of mussels including Perna viridis, Perna Leg, Mytilopsis leucophaeata, Brachidontes variabilis and Brachidontes striatulus, barnacles such as Megabalanus tintinnabulum and oysters such as Crassostrea madrasensis.

The main advantages of the method are the possibility of administering biocidal agents in a localized and concentrated manner to bioscaling, which allows for faster and more effective action without offering risks to neighboring native organisms. This is possible because the method provides for the efficient covering of coral colonies in two steps. In the first stage, the biodegradable polymer matrix gel containing the chemical biocide is applied. The gel is formulated to have rheological properties that facilitate its pumping, allow it to be spread throughout the infected area, in addition to having adhesive properties that contribute to its adhesion and fixation under the colonies. After applying the gel, the cross-linking solution is administered to the surface of the gel, promoting its cross-linking and making it rigid to prevent its diffusion into the medium or its detachment.

The possibility of applying the method in an offshore environment is another essential feature, as it allows the use of a pumping system and application with the aid of underwater remotely operated vehicles (ROV). In addition to lower cost and associated risk, the present invention eliminates the need for divers and can be designed for high performance and range of application, which includes both coastal and offshore environments. The present invention makes it possible to maintain vessels against bioscaling before reaching the Brazilian coast, thus avoiding new introductions of bioinvasive species.

The biocidal gel has characteristics that enable its application to control sun coral in regions of the Brazilian coast. It is essential that the chemical matrix that makes up the gel is biodegradable and non-toxic to marine life, since, after the release of all the biocide load, the gel will eventually detach from the already dead coral and will remain in the ocean where it should not cause impacts. The ability of the gel to adhere to the living tissue of the coral and its rheological behavior during and after underwater application should provide efficient coverage of all polyps in the colony, isolating it from the environment in order to reduce food availability and direct attack by controlled release of the biocide. Another relevant property of the system is its chemical stability during the treatment period, as the gel structure must remain intact when submerged in the sea under different conditions, even with the incorporation of the biocide, which are commonly very reactive molecules. Early degradation of the gel would compromise the effectiveness of the treatment.

Thus, the method developed envisages the use of gels with a polymeric matrix consisting of natural polysaccharides that are easily biodegradable and eliminate the need for initiatives to collect material remaining after treatment and highly reactive biocides, so that, after treatment, are quickly transformed into inactive and harmless species for the marine biome. Therefore, in general, the components used in the method are ecologically and environmentally compatible for the application scenario in a marine environment. Furthermore, as they are components with low production costs, they enable large-scale production and application, expanding the reach of invaded regions that can be treated and recovered.

Regarding the efficiency of combating sun coral, the results demonstrated that the method of the present invention has a high capacity to cause the death of colonies, reaching lethality rates of 100%. Once covered by the gel or damaged/killed by its action, corals become unable to release larvae, which compromises one of their main dissemination strategies. Thus, in addition to eliminating pre-existing colonies, the method of the present invention also prevents the formation of new colonies from larvae, thus being a promising strategy for the eradication of sun coral on the Brazilian coast. Such characteristics shown by the present invention overcome one of the major disadvantages of the manual scraping strategy, which results in the release of larvae and residues due to the mechanical aggression exerted during the operation.

The performance of the formulations comprising the components mentioned above in different concentrations are described in Table 1. These formulations were evaluated for application submerged in seawater, the ability to adhere to sun coral colonies and the ability to damage/kill sun coral polyps.

TABLE 1
Composition of tested formulations

| Formu- | | | Weighting | Cross- |
|---|---|---|---|---|
| lation | Matrix | Biocid | agent | linker |
| 1 | Sodium alginate | Active | Sodium | Calcium |
| | 5% w/w | chlorine | chloride 19.55 | chloride |
| | | 0.17% w/w | g/L | 0.6 g/mL |
| 2 | Sodium alginate | Active | Sodium | Calcium |
| | 5% w/w | chlorine | chloride 39.1 | chloride |
| | | 0.17% w/w | g/L | 0.6 g/mL |
| 3 | Sodium alginate | — | Sodium | — |
| | 1.75% w/w + | | chloride 39.1 | |
| | Portland cement | | g/L | |
| | 4.2% w/w | | | |

### Sample Preparation

### Formulations 1 and 2:

The gels of formulations 1 and 2 were prepared in industrial water with an adjusted density so that the final density of the formulation was slightly higher than the density of seawater. To do this, sodium chloride was added to industrial water in the amount necessary to reach the concentrations indicated in Table 1. Then, sodium alginate was added under mechanical stirring until the indicated concentration was reached.

After preparing the gel matrix, the biocide addition step was carried out close to the moment of underwater application of the formulation to minimize losses in the active chlorine load. In this step, the corresponding volume of sodium hypochlorite was added to the gel matrix under mechanical stirring.

### Formulation 3:

The gel alginate matrix of formulation 3 was prepared as in formulations 1 and 2. After this initial step, Portland cement was added quickly under intense mechanical stirring, around 1.000 rpm, to disperse the cement in the gel. The formulation remained under stirring for approximately 1 minute and 30 seconds and was then applied to the sun coral colonies.

### Cross-Linker Solutions:

The cross-linker solutions were prepared in deionized water by adding the corresponding mass of each cross-linker corresponding to the concentrations indicated in Table 1.

### Assessment of Material Performance

### Identification of Colonies and Evaluation Periods

The formulations described in Table 1 were evaluated in two environments, the experimental tank and an aquarium. Table 2 indicates in which environment each formulation was evaluated, as well as which groups of sun coral colonies were in them.

TABLE 2
Correlation between test environments, tested formulations
and groups of colonies in each environment

| Environment | Tested formulations | Groups of colonies |
|---|---|---|
| Experimental tank | 1 e 2 | “A”, “B”, “C” and “D” |
| Aquarium | 3 | “G” |

The experimental tank used has a volume of around 500 L filled with seawater and has a side tap that allows water to be exchanged. The tank is also equipped with a continuous oxygenation system to better simulate the real marine environment.

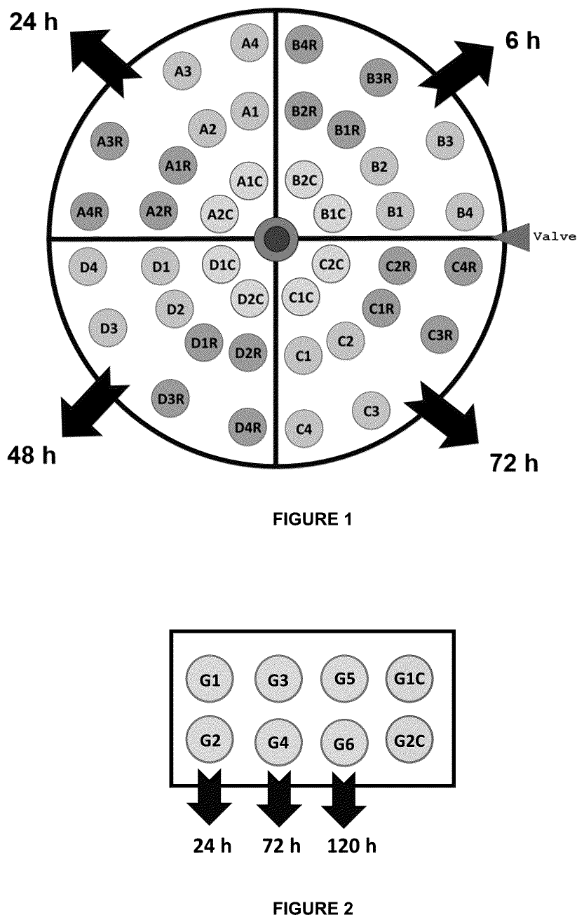

The arrangement of the groups of colonies in the experimental tank is shown in FIG. 1, each group of colonies is associated with a time interval for evaluating the effectiveness of the formulations in attacking the sun coral colonies. Each group has 10 colonies of sun coral, within each group there are 3 subgroups: the subgroups without a suffix, e.g. “B1”, were exposed to a single application of formulation 1 during the time periods indicated in FIG. 1, the subgroups with suffix “R”, e.g. “B1R”, were exposed to formulation 1 at the indicated time intervals, as well as subgroups without a suffix, and also to a reapplication of formulation 2 gel after the evaluation time of all subgroups exposed to the formulation 1, i.e. 72 hours after the first application.

For example, the “A2R” colony was exposed to formulation 1 for 24 hours and, after this period, the gel was removed. After 48 hours without exposure to the gel (totaling 72 hours), the colony was exposed to the gel of formulation 2 for another 24 hours.

The subgroups with the suffix “C”, e.g. “B1C”, are the so-called control subgroups that were not exposed to any of the gel formulations but were exposed to the same environment as the colonies that received gel. The “control” subgroups aim to demonstrate whether the damage caused by the formulations is actually caused by them or whether the colonies were harmed simply by being exposed to the environment in which the gels are applied.

In addition to the control subgroups, two tanks, called control tanks, were monitored without the application of any formulation. The purpose of comparing the experimental tank with the control tanks is to demonstrate whether, if damage occurred, it occurred as a result of the application of the formulations or whether the sun coral colonies listed were already weakened as a result of the own life cycle of the animal.

Formulation 3 was applied to an approximately 45 L aquarium filled with seawater. The distribution of colony groups in the aquarium and the exposure time intervals to the formulation are shown in FIG. 2.

In FIG. 2, the letter “G” represents the group of colonies evaluated with formulation 3 and the subgroups with the suffix “C” indicate the control subgroup. The seawater in the aquariums was changed daily in order to try to better simulate the real marine environment.

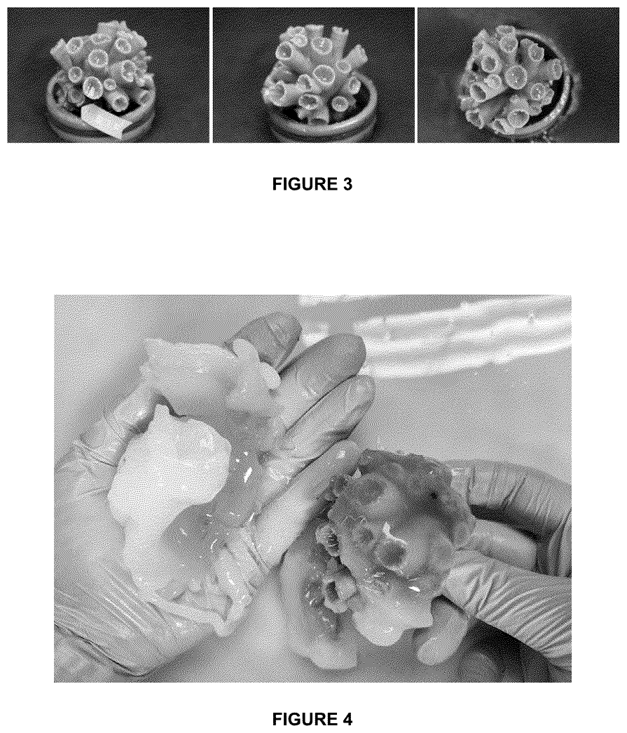

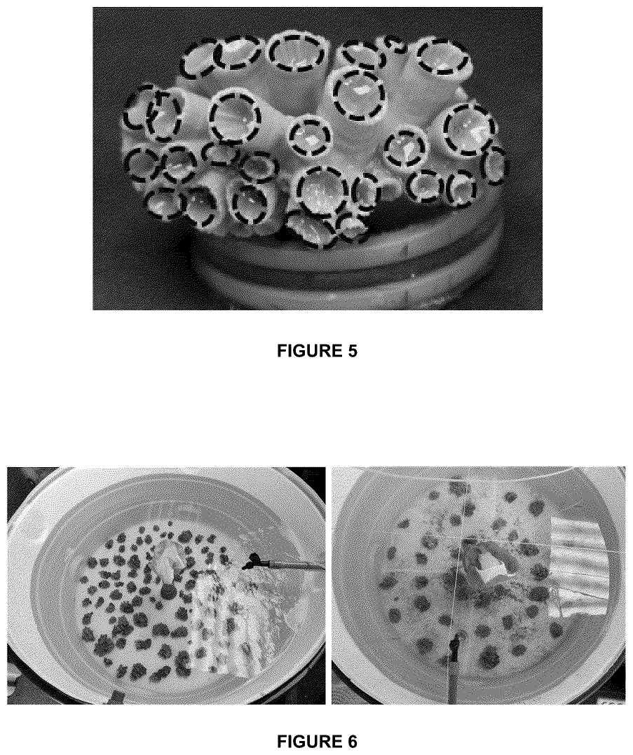

To visually analyze the effects of exposure to each formulation, photographic records were taken for all colonies in three positions: front, rear and top, as illustrated in FIG. 3. In the experimental tank, photographic records were taken in 5 moments: prior to the application of the gels, after the respective time interval of formulation 1, after removal of formulation 1 from all groups, i.e., 72 hours after application, after the respective time interval of formulation 2 and after removal of the gel from formulation 2 from all groups.

In the aquarium, the photographic record took place in 3 moments: before the application of the gels, after the respective time interval for each evaluation and after removing the formulation from the last evaluation group, that is, after 120 hours of application.

In FIG. 3 it is also possible to observe the presence of identification labels in the front view image. All colonies were labeled to aid in identification and photographic records.

After the exposure time intervals to the gels of each group, indicated in FIGS. 1 and 2, the gels were removed from the surface of the colonies. To do this, the colonies in question were removed from the experimental tank or aquarium, the gel was removed mechanically, as illustrated in FIG. 4 and the colonies were washed with sea water. After complete removal of the gels, the colonies were returned to their respective places in the experimental tank or aquarium.

In FIG. 4 it is possible to observe that the mechanically removed gel carries organic matter from the sun coral, this will be detailed in Results.

### Polyp Count

In order to parameterize the effectiveness of the formulations used in the method of the present invention, in terms of their ability to harm the sun coral, live polyps were counted. The criteria used to classify a polyp as alive was the most conservative: if there was any trace of yellow or orange organic tissue remaining, even if the polyp did not have an extension of its tentacles for feeding, the polyp was considered alive.

In the experimental tank, the counting of live polyps occurred in 3 moments: before the application of the formulations, after the removal of formulation 1 from the last group exposed to the gel for 72 hours and after the removal of formulation 2 from the last group exposed to 72 hours to the gel. In the aquarium, the count occurred in 2 moments: before the application of the formulations and after removing the last group exposed to the gels, 120 hours after application.

Table 3 shows the initial amounts of live polyps in each test environment. We sought to maintain the number of polyps similar in each environment for better statistical precision in evaluating the results.

TABLE 3
Initial number of live polyps in each test environment

| | |
|---|---|
| Group of colonies | Live polyps |

Experimental tank

| | |
|---|---|
| A | 426 |
| B | 428 |
| C | 417 |
| D | 417 |

Aquarium

| | |
|---|---|
| G | 313 |

### Sun Coral Feeding

To better simulate a real marine environment and not promote aggression to the sun coral colonies due to starvation, all sun coral colonies (experimental tank, control tanks and aquarium) were fed with zooplankton.

Feeding occurred in 3 moments: before the start of the tests, after the total removal of the first application of gel in the experimental tank, that is, 72 hours after the first application of the experimental tank and after the total removal of the gels from the second application in the experimental tank, again, 72 hours after the second application. The zooplankton used for feeding was always collected on the day the feeding occurred.

Feeding with zooplankton also helped in counting live polyps after applying the formulations, since when in the presence of plankton, sun coral polyps extend their tentacles for feeding.

### Submerged Application of Formulations on Sun Coral Colonies

All formulations were applied to sun coral colonies submerged in seawater with the aid of syringes, where the syringe was positioned close to the surface of the sun coral polyps and its contents were poured slowly in order to try to cover the entire surface of the colony with the gels. For each sun coral colony, approximately 250 mL of the gel formulations were used.

In formulations 1 and 2, in situ cross-linking of alginate gels was promoted. To do this, after applying the gel, the respective cross-linking solutions were applied again using syringes on the gels. About 200 mL of calcium chloride solution was applied per sun coral colony in the experimental tank.

### Results

### Experimental Tank

### First Application

FIG. 6 shows images of both tanks, control and experimental, prior to the start of the experiments. In both cases, it is noted that the water in the tanks was clear and tasteless.

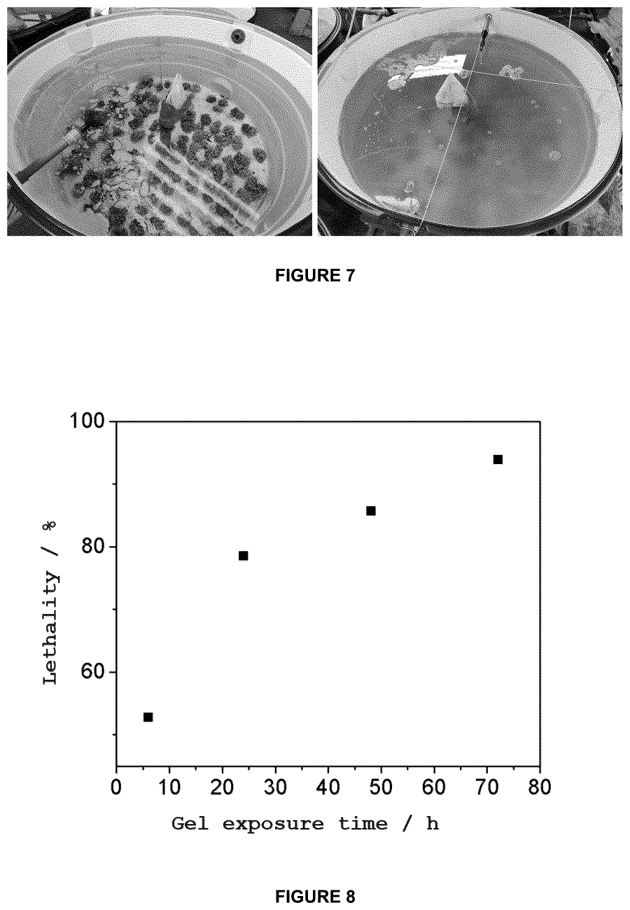

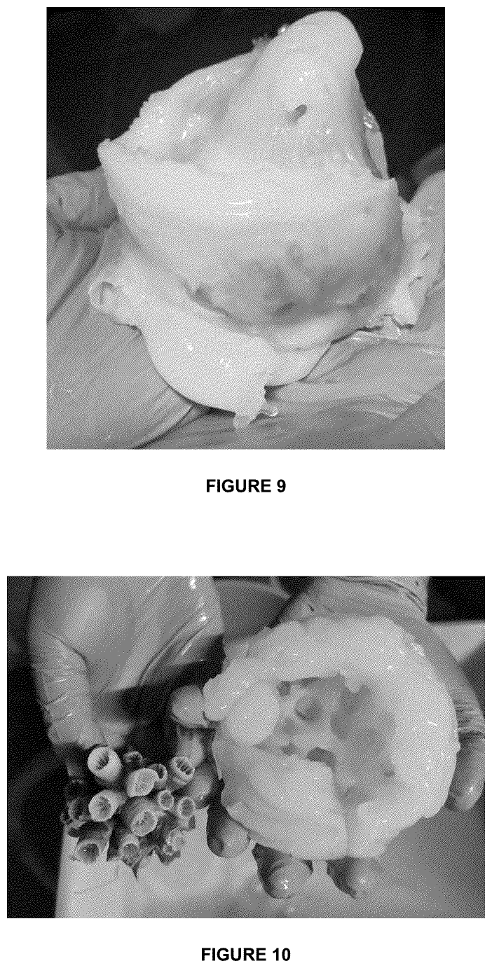

For the first application, carried out with formulation 1, the preparation protocol was followed: active chlorine was added to the alginate matrix thickened under mechanical stirring and left under stirring for 30 minutes for homogenization. After 4 hours of rest to reduce the number of incorporated bubbles and adjust the viscosity of the gel, the formulation was applied to the colonies. FIG. 7 compares the control and experimental tanks again, this time 48 hours after applying the gel, it was noted that the water in the experimental tank showed high turbidity and a strong odor of decomposing organic matter, probably associated with aggression and death of the sun coral colonies as will be discussed later. The water in the tank was completely replaced, but returned to the same state, cloudy and with the odor of decomposing organic matter, after another 24 hours, that is, 72 hours after applying the gels.

As seen in FIG. 4, during the mechanical removal of the gels, it was noted that organic matter from the sun coral colonies was removed along with the gels, leaving a large area of exposed skeleton in each colony. This finding was observed for all groups investigated and demonstrates that the formulation was successful in attacking the sun coral colonies. Furthermore, after removing the gels, the polyps showed discoloration of the organic tissue in proportion to the time in contact with the gel, another sign of aggression, this time possibly associated with the presence of active chlorine. Therefore, it was observed that the tested formulation attacked the sun coral colonies chemically and mechanically.

Signs of aggression were observed in the control colonies, such as the whitening of the polyps, but to a lesser extent when compared to the colonies in the groups where the gel was applied. The possible causes of aggression to the “control” colonies will be described after the final polyp count in the Final Assessment.

Table 4 shows the comparison of the count of live polyps in the colonies of all groups where the gel was reapplied and the average lethality per group. It was noted that, as the time of exposure to the gel increases, the average lethality increases, as illustrated in the graph in FIG. 8.

TABLE 4
Comparison of the live polyp count of the colonies where the gel
will be reapplied in all groups and the average lethality rates

| Group B | | | Group A | | |
|---|---|---|---|---|---|
| 6 hours of exposure | | | 24 hours of exposure | | |
| | | After | | | After |
| Colony | Initial | application | Colony | Initial | application |
| B1R | 35 | 10 | A1R | 26 | 2 |
| B2R | 75 | 34 | A2R | 33 | 7 |
| B3R | 43 | 23 | A3R | 50 | 10 |
| B4R | 23 | 16 | A4R | 17 | 8 |
| Total | 176 | 83 | Total | 126 | 27 |
| Lethality (%) | | 53 | Lethality (%) | | 79 |
| Group D | | | Group C | | |
| 48 hours of exposure | | | 72 hours of exposure | | |
| | | After | | | After |
| Colony | Initial | application | Colony | Initial | application |
| D1R | 42 | 7 | C1R | 43 | 2 |
| D2R | 19 | 3 | C2R | 35 | 4 |
| D3R | 26 | 6 | C3R | 61 | 2 |
| D4R | 46 | 3 | C4R | 40 | 3 |
| Total | 133 | 19 | Total | 179 | 11 |

| | | | |
|---|---|---|---|
| Lethality (%) | 86 | Lethality (%) | 94 |

After removing the gel from all groups of colonies, zooplankton was fed. The colonies in the “control” tanks did not present problems or any variation in behavior, showing full extension of their tentacles during feeding. The colonies in the experimental tank showed varied behaviors. A small part extended its tentacles in a similar way to the colonies in the control tank, one part showed no reaction to the presence of zooplankton, indicating the death of the polyp and another part exposed the tentacles, but in an anomalous way, with incomplete extension of the tissue, indicating aggression to the polyps, but not their death.

### Reapplication

During reapplication, formulation 2 was applied instead of formulation 1. The only difference between these formulations is the amount of weighting agent present.

It was observed that the reapplication of gel considerably increased the whitening of the polyps, indicating damage or even death. In all cases, the colonies have their inorganic skeleton almost completely exposed, with almost no presence of remaining organic tissue.

During the mechanical removal of the gels, it was noted that the amount of organic matter detached from the sun coral colonies together with the gel dropped considerably even with the greater coating efficiency and rigidity of the gel as can be seen in the image of the FIG. 10. This is associated with the lower amount of organic tissue, organic tissue in the colonies thanks to the damage caused by the first application.

### Final Evaluation

After removing the last reapplication gel, all tanks were fed with zooplankton, the sun coral colonies in the control tanks exposed the polyps to feed. The colonies in the experimental tank, for the most part, did not extend their tentacles or, in some cases, did so in a retracted manner. Feeding with zooplankton helped in the final count of live polyps.

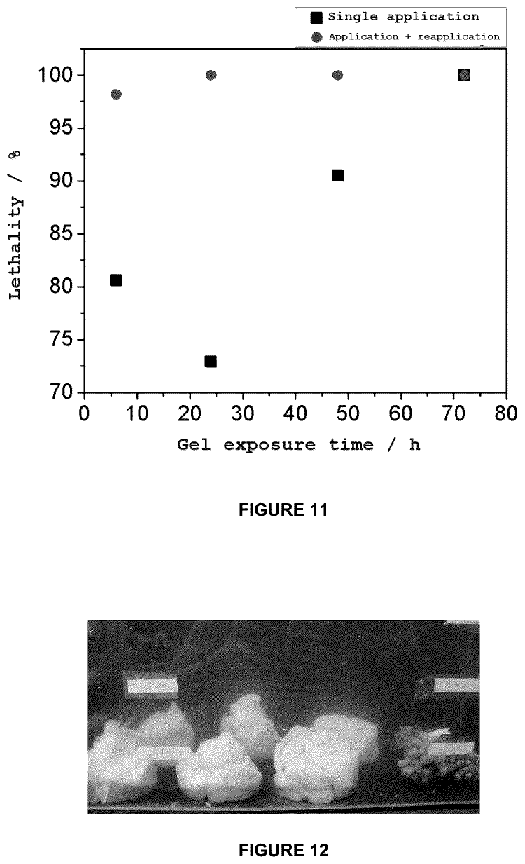

In all groups, a decrease in healthy organic tissue, yellowish or orange, in the sun coral polyps was clearly noted, accompanied by the whitening of its skeleton. Visually, the subgroups that underwent gel reapplication suffered greater damage, which is reinforced by the final count of live polyps shown in Table 5 and the comparative graph between single application versus application and reapplication in FIG. 11.

TABLE 5
Comparison of the count of live polyps in the colonies after
the respective exposure times of each group to the gels.
Group B

| 6 hours of exposure | | | Reapplication | | |
|---|---|---|---|---|---|
| | | After | | | After |
| Colony | Initial | application | Colony | Initial | application |
| B1 | 37 | 0 | B1R | 35 | 1 |
| B2 | 45 | 5 | B2R | 75 | 2 |
| B3 | 44 | 2 | B3R | 43 | 0 |
| B4 | 70 | 31 | B4R | 23 | 0 |
| Total | 196 | 38 | Total | 176 | 3 |

| | | | |
|---|---|---|---|
| Lethality (%) | 81 | Lethality (%) | 98 |

Group A

| 24 hours of exposure | | | Reapplication | | |
|---|---|---|---|---|---|
| | | After | | | After |
| Colony | Initial | application | Colony | Initial | application |
| A1 | 49 | 21 | A1R | 26 | 0 |
| A2 | 66 | 18 | A2R | 33 | 0 |
| A3 | 51 | 2 | A3R | 50 | 0 |
| A4 | 26 | 11 | A4R | 17 | 0 |
| Total | 192 | 52 | Total | 126 | 0 |

| | | | |
|---|---|---|---|
| Lethality (%) | 73 | Lethality (%) | 100 |

Group D

| 48 hours of exposure | | | Reapplication | | |
|---|---|---|---|---|---|
| | | After | | | After |
| Colony | Initial | application | Colony | Initial | application |
| D1 | 40 | 1 | D1R | 42 | 0 |
| D2 | 39 | 5 | D2R | 19 | 0 |
| D3 | 31 | 0 | D3R | 26 | 0 |
| D4 | 90 | 13 | D4R | 46 | 0 |
| Total | 200 | 19 | Total | 133 | 0 |

| | | | |
|---|---|---|---|
| Lethality (%) | 90 | Lethality (%) | 100 |

Group C

| 72 hours of exposure | | | Reapplication | | |
|---|---|---|---|---|---|
| | | After | | | After |
| Colony | Initial | application | Colony | Initial | application |
| C1 | 45 | 0 | C1R | 43 | 0 |
| C2 | 31 | 0 | C2R | 35 | 0 |
| C3 | 41 | 0 | C3R | 61 | 0 |
| C4 | 50 | 0 | C4R | 40 | 0 |
| Total | 167 | 0 | Total | 179 | 0 |

| | | | |
|---|---|---|---|
| Lethality (%) | 100 | Lethality (%) | 100 |

The apparent anomaly of the difference in performance regarding lethality between single applications in groups B and A, 6 and 24 hours of exposure respectively, is possibly associated with failures in the complete coverage of the surface of the sun coral colonies, since, as previously noted, it is very important to cover all the polyps in the colonies efficiently, as polyps that are not well covered tend to survive.

It was clearly noted that the average lethality in the subgroups where there was reapplication was higher than in the groups with a single application, with the only exception being group C, which was exposed to the gel for 72 hours. The greater effectiveness of the gel may also be associated with the act of reapplication or the much more efficient covering of colonies.

Table 6 shows the comparison of the initial and final live polyp counts of the control colonies of all groups.

TABLE 6
Comparison of the live polyp count of the control
colonies of all groups at the beginning of the experiment
and after removing all reapplication gels

| | |
|---|---|
| Group B | Group A |

| Colony | Initial | Final | Colony | Initial | Final |
|---|---|---|---|---|---|
| B1C | 25 | 0 | A1C | 36 | 11 |
| B2C | 31 | 12 | A2C | 63 | 36 |
| Total | 56 | 12 | Total | 99 | 47 |

| | | | |
|---|---|---|---|
| Lethality (%) | 79 | Lethality (%) | 52 |

| | |
|---|---|
| Group D | Group C |

| Colony | Initial | Final | Colony | Initial | Final |
|---|---|---|---|---|---|
| D1C | 44 | 26 | C1C | 53 | 17 |
| D2C | 40 | 12 | C2C | 27 | 4 |
| Total | 84 | 38 | Total | 80 | 21 |

| | | | |
|---|---|---|---|
| Lethality (%) | 55 | Lethality (%) | 74 |

From the analysis of Table 6, it is noted that the average lethality in the control colonies was considerably lower than the average lethality of the colonies that were exposed to the gel, indicating that the performance is in fact associated with the gel coating, not just the environment. However, the average lethality of the control colonies was not negligible, this is possibly associated with the high concentration of active chlorine to which they were exposed, an effect that will be greatly reduced when applying the gel in the open sea due to rapid dilution.

Another factor that may have harmed the control colonies is the high concentration of calcium chloride to which they were exposed during the cross-linking of the gels. In a hypothetical scenario without water exchange, the “control” colonies were exposed to a concentration of 11.5 g/L of calcium chloride (103.8 mmol/L) adding the two cross-linker applications. Again, under application conditions in a marine environment, this effect will be drastically attenuated or even eliminated due to rapid dilution.

### Aquarium

### Formulation 3 Aquarium

The image in FIG. 12 shows the test tank for formulation 3 after applying the gel. It was observed that, after application, the base of the sun coral colonies began to expel a dark reddish liquid, possibly associated with some defense mechanism of the animal.

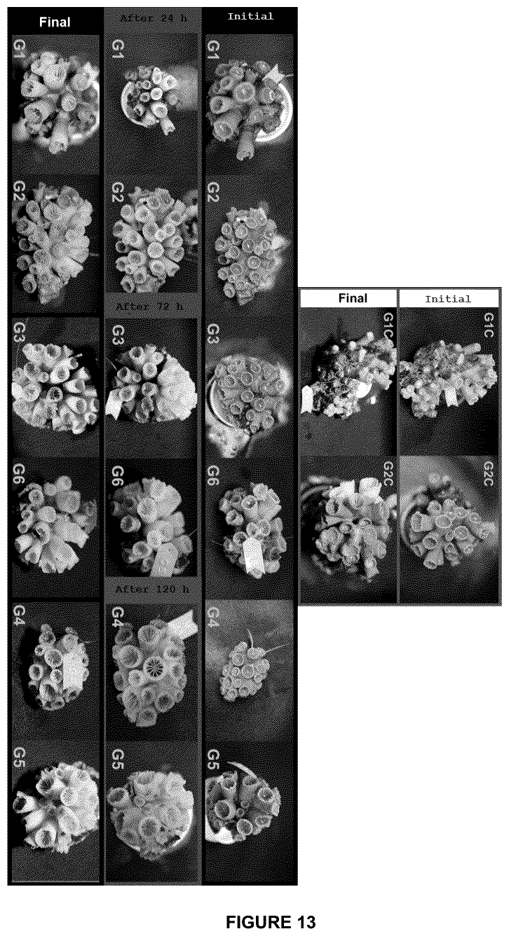

FIG. 13 shows images of the sun coral colonies studied in the aquarium of formulation 3 prior to the application of the gel, after the evaluation periods and after the end of the experiment and feeding with zooplankton. Again, it is noted that the colonies covered with gel were attacked and led to death. On the other hand, the “control” colonies remained alive, indicating that the damage observed in the treated colonies was in fact caused by the gel coating and not by the environment to which they were exposed.

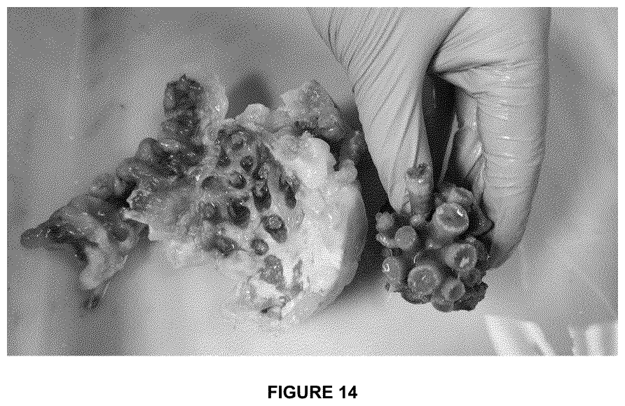

During the test, it was noted that the gels of formulation 3 became quite rigid over time, probably associated with the presence of cement in the formulation. This high rigidity resulted in considerable mechanical aggression during the removal of the gels, as can be seen in the image in FIG. 14. After removing the gel, a strong odor of decomposing organic matter was noticed.

### Performance of Formulation 3 in the Aquarium

Tables 7 and 8 show comparisons of the initial and final counts of live polyps of the sun coral colonies studied in the aquarium, which were exposed to the formulation 3 and control colonies respectively.

TABLE 7
Comparison of initial and final counts of live
polyps from colonies exposed to formulation 3
Group G

| | | After | | | After |
|---|---|---|---|---|---|
| Colony | Initial | application | Colony | Initial | application |
| G1 | 39 | 4 | G2 | 31 | 0 |
| G3 | 55 | 0 | G4 | 28 | 0 |
| G5 | 31 | 2 | G6 | 27 | 0 |

| | | |
|---|---|---|
| Total | 211 | 6 |

| | |
|---|---|
| Lethality (%) | 97 |

TABLE 8
Comparison of the initial and final counts of live
polyps of the control colonies studied in the aquarium
Group G

| Colony | Initial | Final |
|---|---|---|
| G1C | 57 | 44 |
| G2C | 45 | 42 |
| Total | 102 | 86 |

| | |
|---|---|
| Lethality (%) | 16 |

From the data in Table 7, it is noted that formulation 3 showed excellent performance in terms of the ability to attack the sun coral colonies and lead them to death.

Since the “control” colonies showed low lethality, it can be considered that the good performance in terms of the ability to attack and kill the sun coral colonies was in fact derived from the gel coating.

1. A biocidal composition for the elimination of invasive corals of the genus Tubastraea (sun coral) in the marine environment, the composition comprising:
a biocidal-gel, comprising:
1% to 10% w/w sodium alginate;
0.25% to 10% w/v sodium chloride; and
0.05% to 5% w/w sodium hypochlorite; and
a cross-linking agent, comprising:
0.2 g/mL to 0.8 g/mL of calcium chloride (CaCl₂).

2. The composition of claim 1, wherein the sodium alginate can be replaced by water-soluble biopolymers selected from the group of chitosan, pectin, guar gum or cellulose.

3. The composition of claim 1, wherein the sodium chloride can be replaced by density controlling additives selected from the group of salts, hydroxides and/or metal oxides of families 1A and 2A, calcite, hematite, sand, silt, or fine limestone,
preferably 0.4 to 4% w/w of sodium, magnesium, potassium, and/or calcium chlorides and hydroxides.

4. The composition of claim 1, wherein the sodium hypochlorite can be replaced by chemical biocides selected from the group of acetic acid and ammonium persulfate.

5. The composition of claim 1, wherein the calcium chloride (CaCl₂)) can be replaced by cross-linking agents selected from the group of ammonium persulfate and inorganic minerals that make up Portland cement.

6. A method for eliminating invasive corals, the method comprising:
preparing the biocidal composition of claim 1;
applying the biocidal gel within 6 hours after preparing the biocidal composition, wherein the biocidal gel is applied by pumping until a bioscaling is completely covered by the biocidal gel;
applying the cross-linking solution by pumping the bioscaling covered by the biocidal gel until the biocidal gel is completely covered; and
keeping the biocidal composition covering the coral colonies for at least 48 hours.
